(19) United States
(12) Patent Application Publication
(10) Pub. No.: US 2015/0228442 A1
(43) Pub. Date: Aug. 13, 2015

(54) DEVICE FOR PRODUCING X-RAY RADIATION

(71) Applicant: SIEMENS AKTIENGESELLSCHAFT, München (DE)

(72) Inventors: Peter Simon Aptaker, Wantage (GB); Paul Beasley, Abingdon (GB); Svetlana Gossmann-Levchuk, Erlangen (DE); Oliver Heid, Erlangen (DE); Timothy Hughes, Wantage (GB)

(21) Appl. No.: 14/428,371

(22) PCT Filed: Sep. 9, 2013
(86) PCT No.: PCT/EP2013/068624

§ 371 Date: Mar. 16, 2015

(30) Foreign Application Priority Data
Sep. 21, 2012 (DE) 10 2012 216 977.6

(51) Int. Cl. H01J 35/14; H05G 1/32; H01J 35/18

(52) U.S. Cl. CPC H01J 35/14; H01J 35/18; H05G 1/32

(57) ABSTRACT

A device for producing x-ray radiation including an anode with a target layer, a cathode for emitting an electron beam a deflection unit for deflecting the electron beam onto the target layer by means of an electric field and a focusing unit for focusing the electron beam is provided.

The present invention relates to a device for producing x-ray radiation in accordance with patent claim 1 and a method for operating a device for producing x-ray radiation in accordance with patent claim 13.

X-ray tubes for producing x-ray radiation are known from the prior art. X-ray tubes comprise a cathode for emitting electrons. The emitted electrons are accelerated toward an anode by a high voltage. In the anode, the electrons are decelerated and, in the process, produce x-ray bremsstrahlung and characteristic x-ray radiation. The x-ray bremsstrahlung has a broad spectral distribution, while the characteristic x-ray radiation comprises a discrete line spectrum. In the x-ray radiation emitted by the x-ray tube, both types of radiation are superposed.

For certain applications, the characteristic x-ray radiation with discrete energies is more suitable than x-ray bremsstrahlung. The practice of filtering x-ray radiation with metallic filters for reducing the bremsstrahlung portion is known. However, such filters also dampen the portion of the characteristic x-ray radiation.

Furthermore, it is known that the bremsstrahlung portion of x-ray radiation emitted by an x-ray tube is anisotropic and comprises a maximum in a forward direction as defined by the direction of the incident electrons. By contrast, the characteristic x-ray radiation is isotropic. U.S. Pat No. 7,436,931 B2 proposes to arrange a window in a direction opposite to the direction of the electrons incident on the anode, for the purposes of channeling x-ray radiation out of an x-ray tube. In order to be able to arrange the electron source outside of this region, the aforementioned document proposes to deflect the electron beam directed onto the anode by means of a magnetic deflection device.

The object of the present invention consists of providing an improved device for producing x-ray radiation. This object is achieved by a device comprising the features of claim 1. A further object of the present invention consists of specifying a method for operating such a device. This object is achieved by a method comprising the features of claim 13. Preferred developments are specified in the dependent claims.

A device according to the invention for producing x-ray radiation comprises an anode with a target layer, a cathode for emitting an electron beam, a deflection unit for deflecting the electron beam onto the target layer by means of an electric field, a focusing unit for focusing the electron beam and an x-ray window for decoupling x-ray radiation produced in the target layer of the anode in a backward direction that is opposite to the direction of the electron beam incident on the target layer. Here, the cathode is arranged laterally offset in relation to the backward direction proceeding from the anode. Advantageously, this device can have a particularly compact embodiment. Advantageously, a particularly small focal spot of the electron beam can be produced on the anode by means of the focusing unit. The deflection unit advantageously permits x-ray radiation produced by the anode to be channeled in the backward direction in relation to the direction of the electrons incident on the anode. As a result, the channeled x-ray radiation comprises a low relative portion of x-ray bremsstrahlung and a high relative portion of characteristic x-ray radiation. In one embodiment of the device, the focusing unit is arranged downstream of the deflection unit in the direction of propagation of the electron beam. Advantageously, the focusing unit can then directly focus the electron beam onto a point of the target layer of the anode.

In one embodiment of the device, the deflection unit comprises a curved shielding tube. Here, a first electrode and a second electrode are arranged within the shielding tube. It is then advantageously possible to apply electrical voltages to the components of the deflection unit which bring about a deflection, along the curvature of the shielding tube, of the electron beam propagating through the deflection unit.

In one embodiment of the device, the focusing unit comprises an inner shell. Here, the anode is arranged within the inner shell. Advantageously, the focusing unit can then focus the electron beam onto the anode. Here, the anode is arranged in a field-free region.

In one embodiment of the device, the inner shell is embodied as a spherical shell. Then, the focusing unit advantageously has a high degree of symmetry, as a result of which well-defined electric fields can be produced.

In one embodiment of the device, the focusing unit comprises an outer shell, wherein the outer shell at least partly surrounds the inner shell. Advantageously, the electron beam can then be focused between the outer shell and the inner shell. Moreover, the electrons of the electron beam can be accelerated in the movement direction between the outer shell and the inner shell.

In one embodiment of the invention, the outer shell is embodied as a spherical shell. Advantageously, this results in a particularly simple and symmetric embodiment of the focusing unit of the device.

In a different embodiment of the device, the outer shell is embodied as a spherical-cap shell. Advantageously, this also results in a compact, simple and symmetric embodiment of the focusing unit.

In one embodiment of the device, the inner shell and the outer shell each comprise at least one opening, which is provided to let the electron beam pass. Advantageously, the electron beam can then be directed and focused onto an anode arranged in the inner shell.

In one embodiment of the device, the latter comprises a collector, which is provided to capture electrons of the electron beam which have passed through the anode. Advantageously, electrons captured by the collector can be fed back into an electric circuit, as a result of which an energy efficiency of the device is improved.

In one embodiment of the device, the collector and the outer shell of the focusing unit together surround the inner shell of the focusing unit. Advantageously, the collector then is suitable for capturing electrons scattered over a larger solid angle range.

In one embodiment of the device, the collector comprises a cylindrical portion, wherein the cylindrical portion of the collector adjoins the outer shell. Here, the outer shell and the cylindrical portion are electrically insulated from one another. Advantageously, the collector then is suitable for capturing a large part of the electrons of the electron beam directed onto the anode. Here, a different electric potential can advantageously be applied to the collector than to the outer shell of the focusing unit. In a method according to the invention for operating a device for producing x-ray radiation, a first electrical voltage is applied to the shielding tube and the outer shell relative to the cathode. Here, a second electrical voltage is applied to the first electrode relative to the cathode. Moreover, a third electrical voltage is applied to the inner shell relative to the cathode. Here, the first voltage has a higher positive voltage value than the second voltage. Moreover, the third voltage has a higher positive voltage value than the first voltage. Advantageously, the electron beam is then deflected in the deflection unit. Moreover, the electron beam is focused between the outer shell and the inner shell of the focusing unit. Moreover, the electrons of the electron beam are accelerated in the movement direction between the outer shell and the inner shell.

In one embodiment of the method, the first electrical voltage is likewise applied to the second electrode relative to the cathode. Advantageously, the electrons of the electron beam then do not experience a change in the magnitude of the velocity thereof within the deflection unit.

In one embodiment of the method, a fourth electrical voltage is applied to the collector relative to the cathode. Here, the fourth voltage has a higher positive voltage value than the first voltage. Moreover, the third voltage has a higher positive voltage value than the fourth voltage. Advantageously, electrons of the electron beam which have passed through the anode are then decelerated by the collector, as a result of which some of the energy of the electrons is recuperated. As a result of this, the method advantageously has a high energy efficiency.

The above-described properties, features and advantages of this invention, and the manner in which they are achieved, will become clearer and more readily understandable in conjunction with the following description of the exemplary embodiments, which are explained in more detail in conjunction with the drawings. In detail:

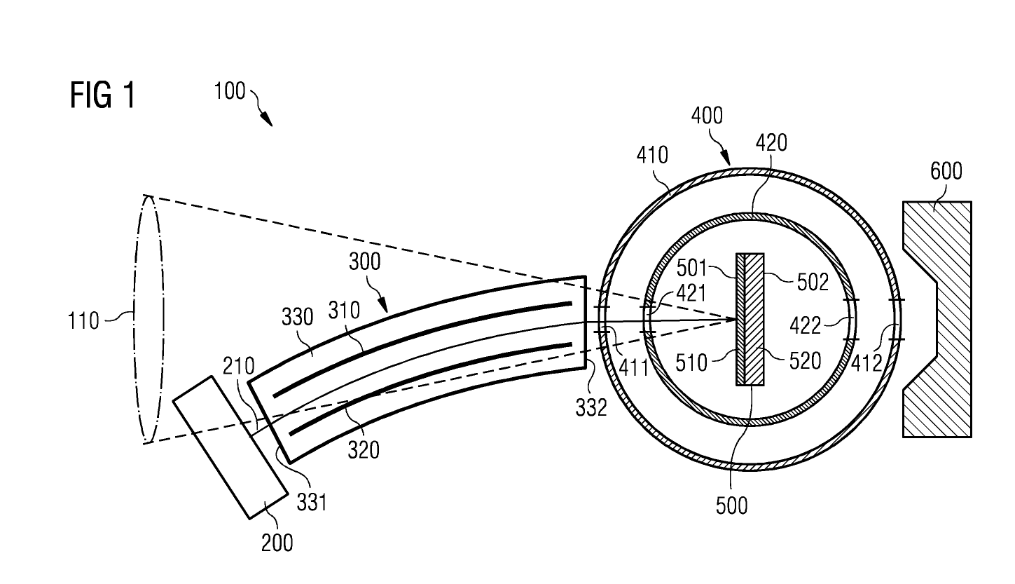

FIG. 1 shows a schematic sectional illustration of a device for producing x-ray radiation in accordance with a first embodiment;

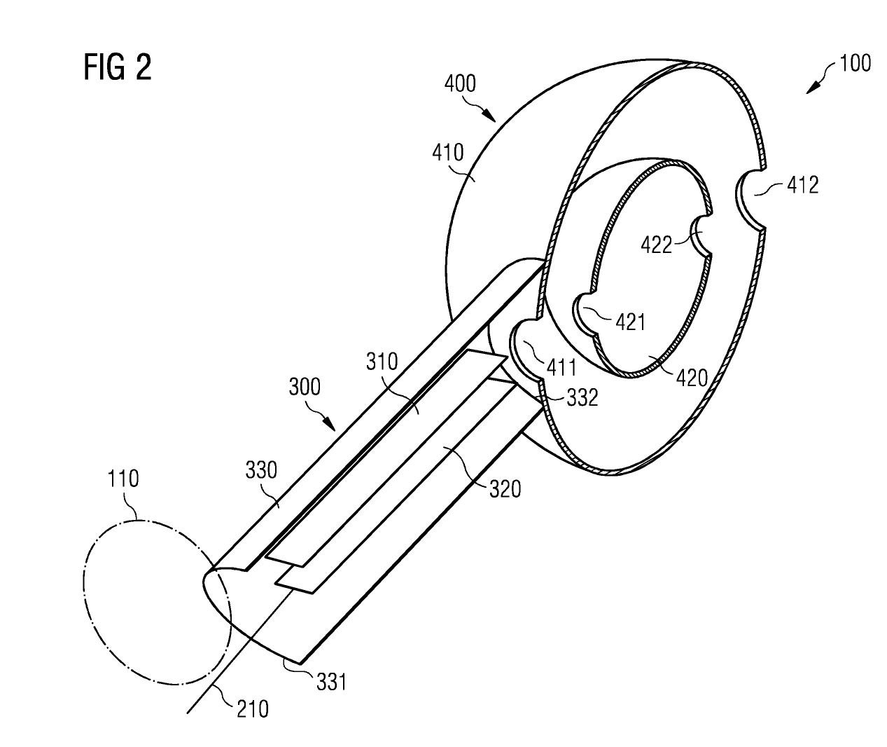

FIG. 2 shows a schematic perspective illustration of the device for producing x-ray radiation;

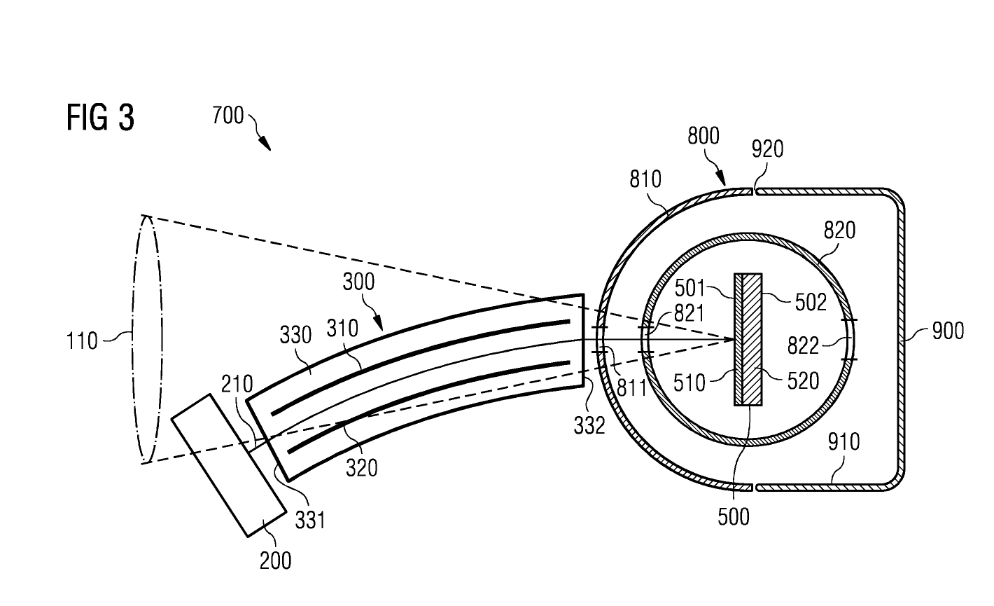

FIG. 3 shows a schematic sectional illustration of a device for producing x-ray radiation in accordance with a second embodiment; and

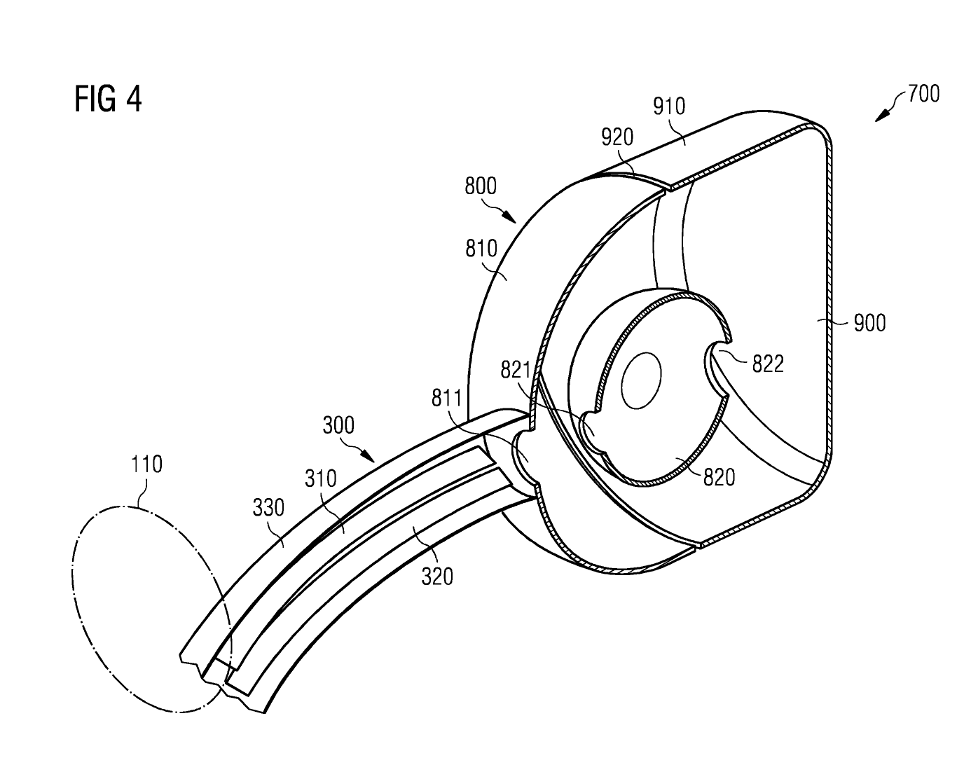

FIG. 4 shows a schematic perspective illustration of the device for producing x-ray radiation in the second embodiment.

FIG. 1 shows a device 100 for producing x-ray radiation in a very schematic sectional illustration. The components of the device 100 for producing x-ray radiation, which are shown in FIG. 1, can be arranged in a vacuum tube. In this case, the device 100 for producing x-ray radiation can also be referred to as an x-ray tube. FIG. 2 shows a schematic perspective illustration of the device 100 for producing the x-ray radiation. For reasons of clarity, some components of the device 100 are not depicted in FIG. 2.

The device 100 comprises a cathode 200. The cathode 200 is provided for emitting electrons in order to produce an electron beam 210. By way of example, the cathode 200 can emit the electrons by thermal emission or by field emission.

The device 100 furthermore comprises a deflection unit 300. The deflection unit 300 is provided for deflecting the electron beam 210 emanating from the cathode 200, i.e. for modifying the direction of the electron beam 210. The deflection unit 300 comprises a curved shielding tube 330 made of an electrically conductive material, for example a metal. A first longitudinal end 331 of the shielding tube 330 faces the cathode 200. Electrons of the electron beam 210 emitted by the cathode 200 can enter into the shielding tube 330 through the first longitudinal end 331.

A first electrode 310 and a second electrode 320 are arranged within the shielding tube 330 of the deflection unit 300. The first electrode 310 and the second electrode 320 respectively have the form of elongate and curved bands and extend substantially parallel to one another in the longitudinal direction of the shielding tube 330. The curvature of the electrodes 310, 320 substantially corresponds to the curvature of the shielding tube 330. The electrodes 310, 320 are at a distance from one another. A central axis of the shielding tube 330 extends between the first electrode 310 and the second electrode 320. The first electrode 310 and the second electrode 320 each consist of an electrically conductive material, for example of metal.

Electrons of the electron beam 210 entering the shielding tube 330 at the first longitudinal end 331 of the shielding tube 330 can pass through the shielding tube 330 between the first electrode 310 and the second electrode 320. As a result of electrical voltages of suitable magnitude being applied to the first electrode 310, the second electrode 320 and the shielding tube 330, electric fields prevail in the interior of the shielding tube 330 of the deflection unit 300, which electric fields deflect the electrons of the electron beam 210 during the passage through the shielding tube 330 in such a way that the electron beam 210 follows the curvature of the shielding tube 330. As a result of this, the direction of the electron beam 210 is changed. After passing through the deflection unit 300, the electrons of the electron beam 210 leave the shielding tube 330 at the second longitudinal end 332 thereof. The device 100 for producing x-ray radiation furthermore comprises a focusing unit 400. The focusing unit 400 serves to focus the electron beam 210 on a focal spot of a target layer 510 of an anode 500. This is carried out with the goal of producing a focal spot with the smallest possible diameter, as is advantageous e.g. for medical purposes such as angiography.

In the depicted embodiment, the focusing unit 400 comprises an outer shell 410 and an inner shell 420. The outer shell 410 and the inner shell 420 each consist of electrically conductive material, for example a metal. The outer shell 410 and the inner shell 420 are respectively embodied as spherical shells. The outer shell 410 and the inner shell 420 are arranged concentrically in relation to one another. The outer shell 410 comprises a first opening 411. The inner shell 420 comprises a first opening 421. As seen from the center of the coaxially arranged shells 410, 420, the first opening 421 of the inner shell 420 and the first opening 411 of the outer shell 410 are situated in a common radial direction which faces the second longitudinal end 332 of the shielding tube 330 of the deflection unit 300. Electrons of the electron beam 210, which leave the shielding tube 330 of the deflection unit 300 through the second longitudinal end 332, can penetrate into the focusing unit 400 through the first opening 411 of the outer shell 410 and the first opening 421 of the inner shell 420.

In other embodiments of the focusing unit 400, the outer shell 410 and the inner shell 420 can have a different embodiment than the spherical shell form (e.g. an ellipsoid embodiment) and need not necessarily be arranged coaxially either.

If electrical voltages of the suitable magnitude are applied to the outer shell 410 and the inner shell 420 of the focusing unit 400, an electric field pointing in the radial direction is formed between the outer shell 410 and the inner shell 420 of the focusing unit 400, which brings about focusing of the electron beam 210 extending between the first opening 411 of the outer shell 410 and the first opening 421 of the inner shell 420. Here, the electron beam 210 is focused approximately on the common center of the outer shell 410 and the inner shell 420 of the focusing unit 400 as a result of the radial profile of the electric field. Additionally, the electrons of the electron beam 210 are accelerated between the outer shell 410 and the inner shell 420 in such a way that a magnitude of the velocity of the electrons of the electron beam 210 increases. Here, the increase in kinetic energy of the electrons of the electron beam 210 emerges from the potential difference between the outer shell 410 and the inner shell 420.

Arranged in the space surrounded by the inner shell 420 of the focusing unit 400 is the anode 500 of the device 100 for producing x-ray radiation. The anode 500 comprises a holder 520 which holds the target layer 510. By way of example, the holder 520 of the anode 500 can comprise diamond or consist thereof. By way of example, the target layer 510 can comprise tungsten or consist thereof. The anode 500 has a front side 501 and a rear side 502. The front side 501 of the anode 500 is formed by the target layer 510.

The anode 500 is arranged in such a way that the electron beam 210 entering into the focusing unit 400 through the first opening 411 of the outer shell 410 and the first opening 421 of the inner shell 420 is incident on the target layer 510 on the front side 501 of the anode 500. Preferably, the electron beam 210 is incident approximately perpendicular on the target layer 510. Preferably, the anode 500 is arranged in the interior of the inner shell 420 of the focusing unit 400 in such a way that the target layer 510 is situated in the focus of the focusing of the electron beam 210 caused by the focusing unit 400. Then, the focal spot, at which the electrons of the electron beam 210 are incident on the target layer 510 of the anode 500, has a minimum diameter.

The electrons of the electron beam 210 incident on the target layer 510 of the anode 500 are decelerated in the target layer 510, with x-ray radiation being produced. This x-ray radiation is emitted in several or all spatial directions. Here, the x-ray radiation comprises x-ray bremsstrahlung and characteristic x-ray radiation. The portion of the x-ray bremsstrahlung is higher in the forward direction, as defined by the direction of the electron beam 210 incident on the target layer 510, than in the opposite backward direction.

Since a portion of x-ray bremsstrahlung which is as small as possible is desirable for various medical and technical purposes, an x-ray window 110 for channeling-out x-ray radiation produced in the target layer 510 of the anode 500 is situated in the backward direction, i.e. in the direction opposite to the direction of the electron beam 210 incident on the target layer 510, in the device 100 for producing x-ray radiation. Here, the x-ray window 110 can for example cover a solid angle range of +/−20°.

An advantage of the device 100 for producing x-ray radiation consists in the fact that the cathode 200 is at least partly arranged outside the spatial region through which the x-ray radiation channeled-out through the x-ray window 110 passes on its path from the target layer 510 of the anode 500. As a result, the x-ray radiation is not, or only to a small extent, shielded or attenuated by the cathode 200. Arranging the cathode 200 outside of the spatial region covered by the x-ray window 110 is enabled by the deflection unit 300. The latter renders it possible to arrange the cathode 200 with a lateral offset in relation to the backward direction and nevertheless direct the electron beam 210 onto the target layer 510 of the anode 500 in the forward direction opposite to the backward direction.

The device 100 for producing x-ray radiation moreover comprises a collector 600. In the forward direction as defined by the direction of the electron beam 210 incident on the target layer 510, the collector 600 is arranged downstream of the focusing unit 400 and outside of the outer shell 410 of the focusing unit 400.

The collector 600 serves for collecting electrons of the electron beam 210 which have completely penetrated the anode 500 in order to improve an energy efficiency of the device 100. To this end, the inner shell 420 comprises a second opening 422. The outer shell 410 likewise comprises a second opening 412. The second opening 412 of the outer shell 410 and the second opening 422 of the inner shell 420 are arranged on the side of the outer shell 410 and the inner shell 420 lying opposite to the first openings 411, 421. As a result, electrons of the electron beam 210, which have completely passed through the anode 500 after the incidence thereof on the target layer 510, can leave the focusing unit 400 through the second opening 422 of the inner shell 420 and the second opening 412 of the outer shell 410 and can reach the collector 600.

During the operation of the device 100 for producing x-ray radiation, different electric potentials are applied to the different components of the device 100. Here, the cathode 200 can form a ground or reference potential.

Preferably, a common positive electric potential is applied to the shielding tube 330 of the deflection unit 300 and the outer shell 410 of the focusing unit 400. Here, the electrical voltage can for example be 10 kV relative to the cathode 200. This potential is preferably also applied to the second electrode 320 of the deflection unit 300. However, it could also be possible to respectively apply different potentials to the shielding tube 330 of the deflection unit 300, the second electrode 320 of the deflection unit 300 and the outer shell 410 of the focusing unit 400.

A positive potential which is smaller than the potential of the shielding tube 330 of the deflection unit 300 is applied to the first electrode 310 of the deflection unit 300. By way of example, a potential of 1 kV relative to the cathode 200 can be applied to the first electrode 310.

A positive potential which is greater than the potential of the outer shell 410 of the focusing unit 400 is applied to the inner shell 420 of the focusing unit 400. By way of example, a potential of 150 kV relative to the cathode 200 can be applied to the inner shell 420.

A positive potential lying between the potentials of the outer shell 410 and the inner shell 420 of the focusing unit 400 can be applied to the collector 600. By way of example, a potential of 40 kV relative to the cathode 200 can be applied to the collector 600.

FIG. 3 shows, in a very schematic illustration, a section through a device 700 for producing x-ray radiation in accordance with a second embodiment. FIG. 4 shows a schematic perspective illustration of the device 700 for producing the x-ray radiation. For reasons of clarity, some components of the device 700 are not depicted in FIG. 4.

The device 700 for producing x-ray radiation has correspondences with the device 100, depicted in FIGS. 1 and 2, for producing x-ray radiation. Components corresponding to one another are therefore provided with the same reference sign and will not be described in detail again in the following text. In place of the focusing unit 400, the device 700 for producing x-ray radiation comprises a focusing unit 800. The focusing unit 800 comprises an inner shell 820, which is embodied as an electrically conductive spherical shell. The inner shell 820 comprises a first opening 821, through which electrons of the electron beam 210 can enter into the space surrounded by the inner shell 820. The anode 500 is arranged in the interior of the inner shell 820 of the focusing unit 800. Electrons of the electron beam 210, which have completely penetrated through the anode 500, can leave the inner shell 820 through a second opening 822. To this extent, the inner shell 820 of the focusing unit 800 corresponds to the inner shell 420 of the focusing unit 400 of the device 100 for producing x-ray radiation in FIGS. 1 and 2.

The focusing unit 800 of the device 700 for producing x-ray radiation furthermore comprises an outer shell 810. The outer shell 810 consists of an electrically conductive material, for example a metal. The outer shell 810 has the form of part of a spherical shell. The outer shell 810 is embodied as half of a spherical shell. The outer shell 810 can therefore also be referred to as a spherical-cap shell. The outer shell 810 partly surrounds the inner shell 820 of the focusing unit 800. Here, the center of the spherical shell, of which the outer shell 810 forms a part, coincides with the center of the inner shell 820. The outer shell 810 is arranged on the side of the inner shell 820 facing the second longitudinal end 332 of the shielding tube 330 of the deflection unit 300. The outer shell 810 comprises an opening 811, through which the electrons of the electron beam 210, which leave the shielding tube 330 of the deflection unit 300 through the second longitudinal end 332, can enter into the focusing unit 800.

An electric field can also be produced between the outer shell 810 and the inner shell 820 of the focusing unit 800 by applying suitable electrical voltages, which electric field brings about focusing of the electron beam 210 extending between the outer shell 810 and the inner shell 820. Here, the electron beam 210 is once again focused on approximately the center of the inner shell 820 of the focusing unit 800. At the same time, the electric field once again brings about an increase in the magnitude of the velocity of the electrons of the electron beam 210.

In place of the collector 600, the device 700 for producing x-ray radiation has a collector 900. The collector 900 consists of an electrically conductive material, for example a metal, and serves to collect electrons of the electron beam 210 which have completely penetrated the anode 500 in order thereby to increase an energy efficiency of the device 700 for producing x-ray radiation.

The collector 900 comprises a cylindrical portion 910 which, on one side, is closed off by a base portion. The collector 900 therefore has a cup-shaped embodiment. The cylindrical portion 910 of the collector 900 has the same diameter as the outer shell 810 of the focusing unit 800. The open end of the cylindrical portion 910 of the collector 900 adjoins the open end of the outer shell 810. As a result, the inner shell 820 of the focusing unit 800 is surrounded by the outer shell 810 and the collector 900.

An insulation 920 is arranged between the outer shell 810 and the cylindrical portion 910 of the collector 900 and it electrically insulates the outer shell 810 from the collector 900. This renders it possible to apply different electric potentials to the outer shell 810 and the collector 900.

Electrons of the electron beam 210, which have passed through the anode 500, can leave the anode 500 with a broad angle distribution. The change in direction of the electrons in relation to the direction of the electron beam 210 directed to the front side 501 of the anode 500 is caused by collisions of the electrons of the electron beam 210 on the atoms of the target layer 510 and of the holder 520 of the anode 500. By way of example, if the anode 500 comprises a holder 520 made of diamond and a target layer 510 made of tungsten with a thickness of 500 nm, the angle distribution of the electrons which have passed through the anode 500 can lie in the range of approximately +/−60°. In relation to the collector 600 of FIGS. 1 and 2, the collector 900 offers the advantage that the collector 900 can capture electrons from this whole large solid angle range. As a result, the device 700 has a particularly high energy efficiency. Preferably, the second opening 822 of the inner shell 820 has a correspondingly large embodiment in order to let electrons from the whole possible scattered angle range pass.

During the operation of the device 700, the same potentials can be applied to the components of the device 700 for producing x-ray radiation as to the corresponding components of the device 100 for producing x-ray radiation. In particular, a potential of 10 kV relative to the cathode 200 can be applied to the outer shell 810. A potential of 150 kV relative to the cathode 200 can be applied to the inner shell 820 of the focusing unit 800. A potential of 40 kV relative to the cathode 200 can be applied to the collector 900.

Although the invention is depicted more closely and described in detail by preferred exemplary embodiments, the invention is not restricted by the disclosed examples. Other variations can be derived therefrom by a person skilled in the art, without departing from the scope of protection of the invention.

1. A device for producing x-ray radiation, comprising: an anode with a target layer; a cathode for emitting an electron beam; a deflection unit for deflecting the electron beam onto the target layer by means of an electric field; a focusing unit for focusing the electron beam; and an x-ray window for decoupling x-ray radiation produced in the target layer of the anode in a backward direction that is opposite to a direction of the electron beam incident on the target layer, wherein the cathode is arranged laterally offset in relation to the backward direction proceeding from the anode.

2. The device as claimed in claim 1, wherein the focusing unit is arranged downstream of the deflection unit in a direction of propagation of the electron beam.

3. The device as claimed in claim 1, wherein the deflection unit comprises a curved shielding tube, and wherein a first electrode and a second electrode are arranged within the shielding tube.

4. The device as claimed in claim 1, wherein the focusing unit comprises an inner shell, and wherein the anode is arranged within the inner shell.

5. The device as claimed in claim 4, wherein the inner shell is a spherical shell.

6. The device as claimed in claim 4, wherein the focusing unit comprises an outer shell, and wherein the outer shell at least partly surrounds the inner shell.

7. The device as claimed in claim 6, wherein the outer shell is a spherical shell.

8. The device as claimed in claim 6, wherein the outer shell is a spherical-cap shell.

9. The device as claimed in claim 6, wherein the inner shell and the outer shell each comprise at least one opening, which is provided to let the electron beam pass.

10. The device as claimed in claim 1, further comprising a collector, which is provided to capture electrons of the electron beam which have passed through the anode.

11. The device as claimed in claim 10, wherein the collector and the outer shell of the focusing unit together surround the inner shell of the focusing unit.

12. The device as claimed in claim 11, wherein the collector comprises a cylindrical portion, the cylindrical portion of the collector adjoining the outer shell, further wherein the outer shell and the cylindrical portion are electrically insulated from one another.

13. A method for operating a device for producing x-ray radiation as claimed in claims 3, wherein a first electrical voltage is applied to the shielding tube and the outer shell relative to the cathode, a second electrical voltage is applied to the first electrode relative to the cathode, a third electrical voltage is applied to the inner shell relative to the cathode, further wherein the first voltage has a higher positive voltage value than the second voltage, and the third voltage has a higher positive voltage value than the first voltage.

14. The method as claimed in claim 13, wherein the first electrical voltage is likewise applied to the second electrode relative to the cathode.

15. The method as claimed in claim 13, wherein the device produces x-ray beams, further wherein a fourth electrical voltage is applied to the collector relative to the cathode, the fourth voltage having a higher positive voltage value than the first voltage, and the third voltage has a higher positive voltage value than the fourth voltage.
